(19) United States
(12) Patent Application Publication
(10) Pub. No.: US 2025/0144990 A1
(43) Pub. Date: May 8, 2025

(54) ARRANGEMENT FOR A VEHICLE ROOF AND VEHICLE ROOF

(71) Applicant: Webasto SE, Stockdorf (DE)

(72) Inventor: Rudolf DIETL, Stockdorf (DE)

(21) Appl. No.: 18/919,855

(22) Filed: Oct. 18, 2024

(30) Foreign Application Priority Data
Nov. 3, 2023 (DE) 102023130406.2
Jan. 24, 2024 (DE) 102024102018.0

(51) Int. Cl. B60J 10/90; B60J 7/043; B60J 7/057; E05D 15/10; E05F 15/655

(52) U.S. Cl. CPC B60J 10/90; E05D 15/1081; E05F 15/655; B60J 7/043; B60J 7/0573; E05Y 2900/542

(57) ABSTRACT

An arrangement for a vehicle roof has a frame for coupling to the vehicle roof, a first cover which is displaceable relative to the frame in a first direction, a second cover and a third cover which are each attached stationarily to the frame, a guide rail which is linearly extended in the first direction, and a slider which is attached to the first cover and is guided in the guide rail. The guide rail is coupled to the frame, is arranged between the second and third covers in a second direction, and is movable relative to the frame in a third direction. The first direction, the second direction and the third direction are each oriented transversely to one another.

### CROSS-REFERENCE TO RELATED APPLICATION(S)

This application claims the benefit of German Application No. 10 2023 130 406.2 filed Nov. 3, 2023, and German Application No. 10 2024 102 018.0 filed Jan. 24, 2024, which are incorporated herein by reference in their entireties.

### TECHNICAL FIELD

An arrangement is indicated for a vehicle roof, in particular an arrangement for moving a cover for the vehicle roof. Furthermore, a vehicle roof is indicated for a motor vehicle, in particular a vehicle roof having an arrangement described herein.

### BACKGROUND

Arrangements with a movable cover for a vehicle roof may be configured as a so-called externally guided sliding roof, as described for example in DE 197 13 347 C2. Alternatively, it is also possible to configure the vehicle roof as a so-called spoiler roof, as described for example in DE 10 2012 106 545 A1.

### SUMMARY

It is desirable to indicate an arrangement for a vehicle roof which allows reliable operation. It is furthermore desirable to indicate a vehicle roof which allows reliable operation.

According to at least one embodiment, an arrangement is indicated for a vehicle roof. The arrangement has a frame for coupling to the vehicle roof. In particular, the frame can be inserted in a roof opening of the vehicle roof. The arrangement has a first cover. The first cover is displaceable relative to the frame in a first direction. In particular, by means of the displacement of the first cover, it is possible to optionally open and close the roof opening of the vehicle roof. The arrangement has a second cover. The arrangement has a third cover. The second cover and the third cover are each attached stationarily to the frame. In contrast to the first cover, the second cover and the third cover are thus not displaceable relative to the frame in order to open the roof opening. The first cover, the second cover and the third cover together close the roof opening when the arrangement is in the closed state.

The arrangement has a guide rail which is longitudinally extended in the first direction. The guide rail is coupled to the frame. The guide rail is arranged between the second and third covers in a second direction. The guide rail is movable relative to the frame in a third direction. The first direction, the second direction and the third direction are each oriented transversely, in particular perpendicularly, to one another. The arrangement has a slider which is attached to the first cover. The slider is guided in the guide rail.

The arrangement has the first guide rail on which the cover is supported by means of the slider. The support does not take place as conventionally by means of two laterally arranged guide rails. The guide rail is arranged centrally between the second and third covers, so that the slider is guided centrally and the cover is supported centrally.

In order, in particular in the closed state, to allow an arrangement which is as watertight as possible and for example also has a uniformly pleasing appearance, the guide rail is movable in the third direction. Thus it is possible to arrange the guide rail in a lowered position in the closed state. When the cover is to be displaced towards the rear in order to open the roof opening, it is possible to raise the guide rail in the third direction. Thus the guide rail is arranged above the second and third covers in the third direction. This allows the first cover also to be displaceable above the second and third covers. The arrangement is in particular configured as a so-called externally guided sliding roof. The slider may also be called a rear slider or rear deployment lever. The slider is coupled to the cover such that it moves in the first direction together with the cover, when the cover is displaced in the first direction between the closed position and an open position.

The support on the guide rail, which is arranged between the second and third covers, allows a great displacement width for the first cover and hence a roof system which can be opened widely even with comparatively large and heavy covers, which for example have a weight of more than 20 kg, for example around 22 kg or more. Also, greatly waisted or trapezoid first covers may be used, since there is no need for two mutually parallel guide rails in the rear region next to the second and third covers. Because of the movability of the guide rail in the third direction, a stylish appearance and pleasing aesthetics may be achieved. The elements of the arrangement may remain in engagement with one another throughout the entire displacement movement of the first cover, and are always at least indirectly connected to the frame. This allows a robust arrangement which is stable and robust even in the case of an accident.

According to at least one embodiment, the arrangement has a first drive. The arrangement has a second drive. The first drive serves for driving the displacement of the first cover relative to the frame. The second drive serves for driving the movement of the guide rail relative to the frame. For example, the first drive and the second drive each have an electric motor. By means of the first drive, starting from the closed position, the first cover can be raised in the third direction and displaced in the first direction towards the open position. By means of the second drive, the guide rail can be raised and lowered in the third direction between the lowered position, when the first cover is in the closed position, and the raised position. The actuation of the first drive and second drive is set in particular such that, starting from the closed position, the guide rail is raised before the first cover is displaced towards the rear. The closure of the first cover, starting from the open position to the closed position, takes place correspondingly in the reverse order.

According to at least one embodiment, the arrangement has a common drive for driving the displacement of the first cover relative to the frame and for driving the movement of the guide rail relative to the frame. Thus there is no need for two separate drives. In particular, only a single drive is provided, which is configured to drive both the displacement of the first cover and also the movement of the guide rail relative to the frame.

According to at least one embodiment, the slider is configured to surround the guide rail. The guide rail is thus arranged between two side regions of the slider in the second direction. The first guide rail therefore need not be accessible from above. In particular, when the first cover is in the closed position, a watertight closure between the second and third covers is thus possible.

According to at least one embodiment, the arrangement has a first deployment lever and a second deployment lever. The first deployment lever and the second deployment lever are each coupled to the frame. The first deployment lever and the second deployment lever are also each coupled to the guide rail. The first deployment lever and the second deployment lever are each pivotable relative to the frame in order to move the guide rail. In particular, the first deployment lever and the second deployment lever are arranged spaced apart from one another in the first direction. For example, the first deployment lever is arranged at a front end of the guide rail, and the second deployment lever is arranged at a rear end of the guide rail. For example, the second deployment lever is coupled to the second drive. Thus for example, it is possible to pivot the second deployment lever relative to the frame and hence to drive the movement of the guide rail in the third direction.

According to at least one embodiment, the first cover has a front edge. The first cover has a rear edge. The front edge and the rear edge each run in the second direction. The rear edge is shorter than the front edge. The significantly longer front edge leads, in plan view, to a greatly waisted or trapezoid form of the first cover. For example, the front edge is more than 15% longer than the rear edge, for example the front edge is more than 18% longer than the rear edge.

According to at least one embodiment, the first cover has two front supports. The two front supports are arranged at the side in a front region of the first cover. The two front supports are coupled to the frame. The slider is arranged in a rear region of the first cover, centrally in the second direction. The two front supports and the slider are thus arranged in a triangular arrangement. The two front supports are arranged at the front edge of the cover and at respectively assigned side edges of the first cover. The slider is arranged at the rear edge of the first cover, spaced from the side edges and centrally along the rear edge. By means of the two front supports, the first cover is held displaceably on the frame and thus the roof opening can be opened.

According to at least one embodiment, the guide rail has a sloping portion in a front region. This allows the raising and lowering of the slider in the third direction. When the first cover is in the closed position, the slider is arranged at the bottom on the sloping portion. When the slider is moved upward in the third direction along the sloping portion and slightly to the rear in the first direction, the rear edge of the cover is raised into a so-called ventilation position or tilt position. Then the front edge of the cover can be raised in the third direction by means of the two front supports.

According to at least one embodiment, the arrangement has a pivot mechanism for pivoting the slider relative to the guide rail. In this case, it is possible for example to omit the sloping portion in the front region of the guide rail. The guide rail may be configured so as to be straight or only slightly curved along its entire extent in the first direction, in particular without a comparatively greatly sloping portion for raising and lowering the slider. Starting from the closed position, the slider is pivoted by means of the pivot mechanism in order to raise the rear edge of the first cover. For this, for example, the pivot mechanism is coupled to the first drive so that the first drive also drives the pivot mechanism.

According to at least one embodiment, the arrangement has a guide tube which is attached to the first cover. The arrangement has a drive cable which is displaceably guided in the guide tube. The drive cable is coupled to the pivot mechanism. The guide tube and the drive cable, for example, two guide tubes and two drive cables are provided, thus move with the first cover when this is displaced in the first direction.

According to at least one embodiment, the arrangement has a capping. The capping covers the guide rail. When the first cover is in a closed state, the capping is arranged in a space between the second and third covers and seals this, in particular against dust and water. According to some embodiments, for this additional seals and/or plastic mouldings are provided. In plan view from above, the capping covers the guide rail so that this is concealed by means of the capping, in particular when the first cover is in the closed position. The capping can be raised and lowered in the third direction together with the guide rail. The slider is configured such that it is guided from above in the third direction at the side of the capping and the guide rail, and thus surrounds the capping and engages in the side of the guide rail.

According to at least one embodiment, a vehicle roof has an arrangement according to at least one of the embodiments described herein. The vehicle roof has for example a roof opening in which the arrangement is inserted. The roof opening of the vehicle roof is closed by means of the arrangement. The vehicle roof may be formed greatly waisted or trapezoid. The arrangement with the centrally arranged guide rail allows a correspondingly appropriate design of the first cover, the second cover and the third cover, and hence a reliable support of the displaceable first cover.

### BRIEF DESCRIPTION OF DRAWINGS

Further advantages, features and refinements arise from the following examples which are explained in connection with the figures. The same and similar elements, and those with similar function, may be provided with the same reference signs across all figures.

FIG. 1 shows a schematic illustration of a part of a vehicle according to an exemplary embodiment,

FIGS. 2 and 3 each show schematic illustrations of an arrangement according to an exemplary embodiment,

FIGS. 4 to 11 each show schematic illustrations of the arrangement according to an exemplary embodiment,

FIGS. 12 to 18 each show schematic illustrations of the arrangement according to a further exemplary embodiment, and

FIGS. 19 to 21 each show schematic illustrations of the arrangement according to a further exemplary embodiment.

### DETAILED DESCRIPTION

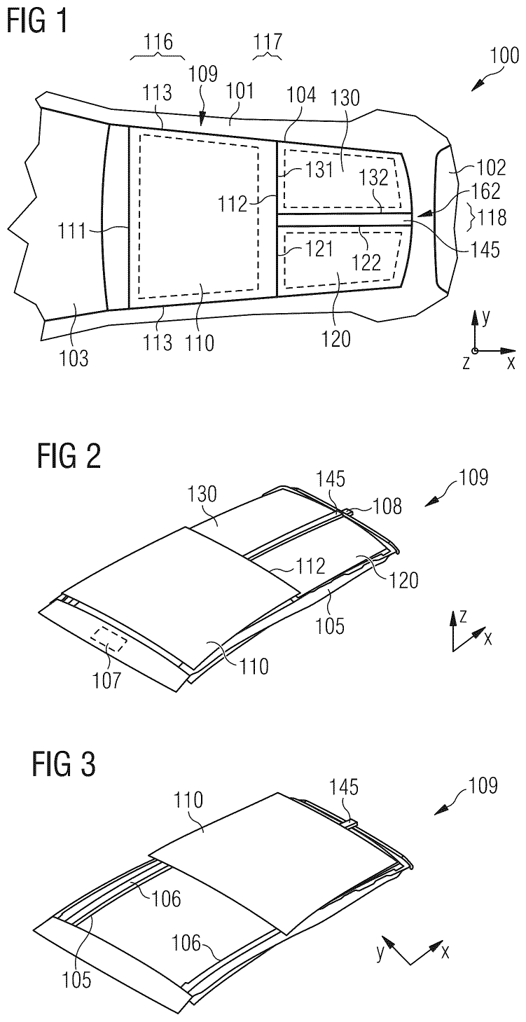

FIG. 1 shows a schematic illustration of a plan view of a vehicle 100. The vehicle 100 is for example a car. The vehicle 100 has a vehicle roof 101. The vehicle roof 101 has an arrangement 109. The arrangement 109 has a first cover 110, a second cover 120 and a third cover 130. By means of the covers 110, 120, 130 and the arrangement 109, a roof opening 104 of the vehicle roof 101 can be closed. By a displacement of the first cover 110 in a longitudinal direction X, the roof opening 104 can be closed in a closed position and at least partly opened in an open position. The closed position may also be called the shut position. The open position may also be called the opened position.

The first cover 110 is displaceable relative to a fixed roof part of the vehicle roof 101 in the longitudinal direction X and in a vertical direction Z, which is transverse thereto, between the closed position illustrated in FIG. 1 and an open position illustrated in FIG. 3. For closing, the first cover 110 is moved opposite the longitudinal direction X.

The first cover 110 has a front edge 111. The first cover 110 has a rear edge 112. The front edge 111 and the rear edge 112 are arranged opposite one another in the longitudinal direction X. The front edge 111 of the first cover 110 faces a windscreen 103 of the vehicle 100. The rear edge 112 of the first cover 110 faces the second cover 120 and the third cover 130. The rear edge 112 of the first cover 110 faces a rear window 102 of the vehicle 100.

Two side edges 113 of the first cover 110 are arranged between the front edge 111 and the rear edge 112, each of which run in a transverse direction Y. In a main extent direction, the side edges 113 each run in the first direction X between the front edge 111 and the rear edge 112 of the first cover 110.

The second cover 120 and the third cover 130 each have a front edge 121, 131. The front edges 121, 131 of the second cover 120 and the third cover 130 each face the windscreen 103, and in the closed position face the rear edge 112 of the first cover 110. In the closed position, the second cover 120 and the third cover 130 are each arranged between the first cover 110 and the rear window 102. The second cover 120 and the third cover 130 are arranged next to one another in the transverse direction Y.

The second cover 120 has a side edge 122. The side edge 122 runs in the longitudinal direction X. The side edge 122 faces the third cover 130.

The third cover 130 has a side edge 132. The side edge 132 runs in the longitudinal direction X. The side edge 132 of the third cover 130 faces the second cover 120.

The side edge 122 of the second cover 120, and the side edge 132 of the third cover 130, are arranged adjacent to and spaced apart from one another in the transverse direction Y. A space 162 is formed between the two side edges 122, 132. In particular, in the transverse direction Y, the second cover 120 and the third cover 130 do not touch one another directly at the two side edges 122, 132.

The arrangement 109 has a capping 145. The capping 145 extends, longitudinally extended, in the longitudinal direction X. The capping 145 is arranged in the space 162 between the second cover 120 and the third cover 130. In the transverse direction Y, the capping 145 is arranged between the second cover 120 and the third cover 130 in order to close the space 162, in particular when the first cover 110 is in the closed position.

When the first cover 110 is in the closed position, the roof opening 104 is thus closed by means of the first cover 110, the second cover 120, the third cover 130 and the capping 145.

The second cover 120 and the third cover 130 are each connected, in particular rigidly and stationarily, to the vehicle roof 101 and are fixedly attached to the vehicle roof 101.

Positional and/or directional terms used in the context of this disclosure, such as rear or front, relate to the vehicle longitudinal direction X, in particular when the arrangement 109 is correctly installed in the vehicle roof 101. The vehicle longitudinal direction X may also be called the X direction. Corresponding positional and/or directional terms such as top or bottom relate to the vertical direction Z. The vertical direction Z may also be called the height direction or Z direction. Positional and/or directional terms such as side or left or right relate to a vehicle transverse direction Y, which may also be called the Y direction. The longitudinal direction X, the transverse direction Y and the vertical direction Z are in particular each perpendicular to one another.

FIG. 2 shows a schematic illustration of the arrangement 100 in the so-called ventilation position or tilt position. The rear edge 112 of the first cover 110 is raised in the vertical direction Z in comparison with the closed position. A substantial movement in the longitudinal direction X for opening the roof opening 104 has not yet taken place.

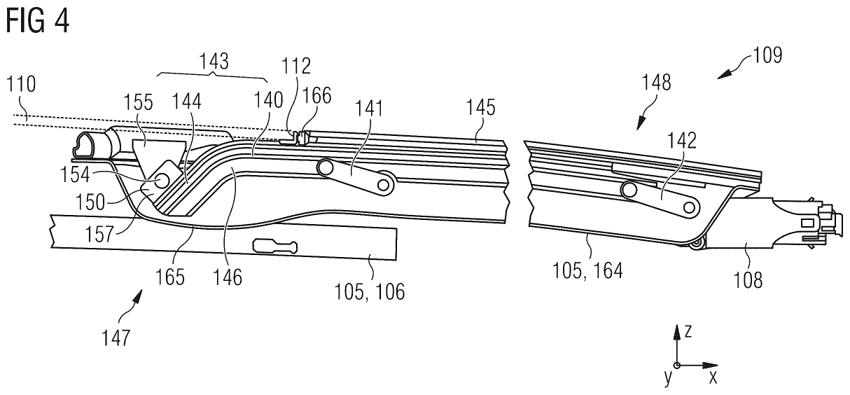

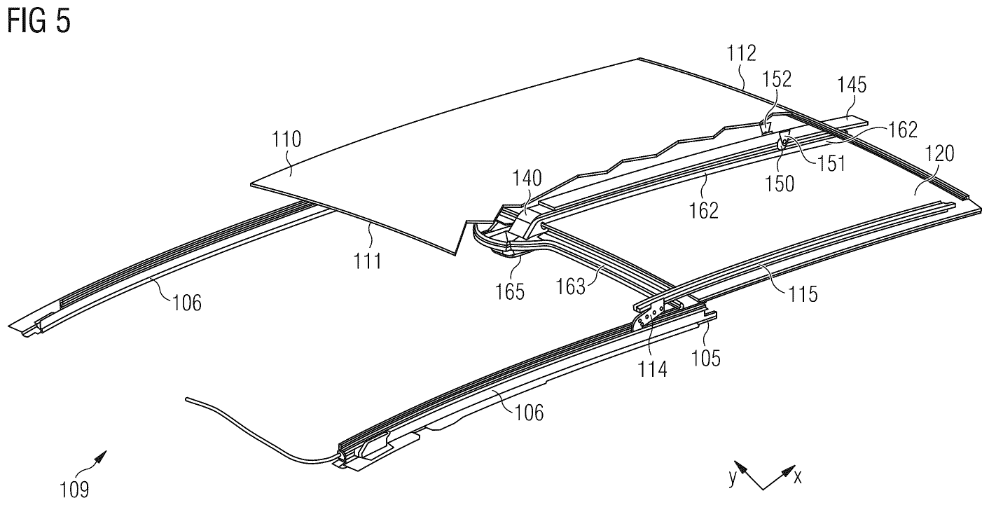

The capping 145 is also raised in the vertical direction Z. The capping 145 is thus arranged higher in the vertical direction Z than the second cover 120 and the third cover 130. As will be evident in detail in the following exemplary embodiments, the capping 145 is arranged on a guide rail 140 (see e.g. FIG. 4). The rear edge 112 of the cover 110 is supported on the guide rail 140. Raising the guide rail 140 and capping 145 in the vertical direction Z allows the first cover 110 to be moved in the longitudinal direction X between the closed position (FIG. 1) and the open position (FIG. 3).

FIG. 3 shows a frame 105 of the arrangement 109. The frame 105 serves for attaching the arrangement 109 to the bodywork of the vehicle 100.

The guide rail 140 is attached to the frame 105, as are two further side guide rails 106. The two side guide rails 106 are arranged in a front region of the frame 105 facing the windscreen 103, and extend, longitudinally extended, in the longitudinal direction X. The guide rail 140 is arranged in a rear region of the frame 105 facing the rear window 102. The guide rail 140, also longitudinally extended, extends in the longitudinal direction X. The two side guide rails 106 are each arranged at the side of the frame 105 in the transverse direction Y. The guide rail 140 is arranged centrally in the transverse direction Y.

The first cover 110 is thus supported at three points. In a front region 116 (FIG. 1), which adjoins the front edge 111 and comprises at most up to 50% of the first cover 110 in the longitudinal direction X, the first cover 110 is supported on the two side guide rails 106. In a rear region 117, which adjoins the rear edge 112 and comprises at most 50% of the first cover 110, starting from the rear edge 112 in the direction of the front edge 115, the first cover 110 is supported on the guide rail 140.

The raising and lowering of the first cover 110 in the vertical direction Z, and the displacement in the longitudinal direction X, can be achieved by means of a first drive 107 of the arrangement 109. The first drive 107 in particular comprises an electric motor, and for example drive cables which are resistant to tension and compression.

The raising and lowering of the guide rail 140 in the vertical direction Z, relative to the frame 105, can be driven by means of a second drive 108 of the arrangement 109. The second drive 108 also has an electric motor for example. The electric motor of the first drive 107 may be configured differently from the electric motor of the second drive 108.

FIGS. 4 to 11 each show schematic illustrations of the arrangement 109 according to an exemplary embodiment.

The guide rail 140 extends, longitudinally extended, in the longitudinal direction X. In a front region 143 facing the windscreen 103, the guide rail 140 has a sloping portion 144. The guide rail extends in the longitudinal direction X between a first end 147, facing the windscreen 103, and a second end 148. The sloping portion 144 directly adjoins the first end 147. The sloping portion 144 slopes obliquely to the longitudinal direction X and obliquely to the vertical direction Z. In the sloping portion 144, a course 146 of the guide rail 140 or a guide channel of the guide rail 140 slopes for example between 30° and 80° relative to the longitudinal direction X. Outside the sloping portion 144, i.e. in particular behind the sloping portion 144, the guide rail 140 has a substantially straight course 146, which corresponds to the longitudinal curvature of the vehicle roof 101. Outside the sloping portion 144, the guide rail 140 extends in a straight line in the longitudinal direction X.

The guide rail 140 is coupled to the frame 105 by means of a first deployment lever 141 and a second deployment lever 142. The frame 105 has a frame centrepiece 164. The first deployment lever 141 and the second deployment lever 142 are each pivotably connected to the frame centrepiece 164 of the frame 105. The frame centrepiece 164 is arranged in the region of the space 162 between the second cover 120 and the third cover 130. The first deployment lever 141 and the second deployment lever 142 are each pivotably connected to the guide rail 140. By pivoting the deployment levers 141, 142 relative to the frame 105, the guide rail 140 can be raised and lowered in the vertical direction Z. The second drive 108 is for example connected to a rotational axis of the second deployment lever 142, so that the pivoting of the second deployment lever 142 can be driven by means of the second drive 108.

FIG. 4 shows the guide rail 140 in the lowered position, in which the first cover 110 is arranged in its closed position. The front region 143 with the sloping portion 144 is arranged in a lowered region 165 of the frame centrepiece 164. Because of the lowered region 165, sufficient stowage space is available for the sloping portion 144. Outside the lowered region 165, the frame centrepiece 164 is formed set back in the vertical direction Z, in order to take up less installation space.

The first cover 110 is supported on the guide rail 140 in the rear region 117 by means of a slider 150. The slider 150 is attached to the first cover 110, in particular to a cover carrier 115. The cover carrier 115 is for example a metal frame which is attached to a pane of the first cover 110, for example by means of a plastic surround-moulding and/or foamed plastic.

The slider 150 is arranged on the first cover 110 in a middle region 118 adjacent to the rear edge 112. The middle region relates to the extent in the transverse direction Y. The middle region 118 is equally spaced from the two side edges 113 in the transverse direction Y. In particular, the slider 150 is equally far away from the two side edges 113 in the transverse direction Y.

At the rear edge 112, the cover 110 is supported on the one single guide rail 140 by means of the one single slider 150. The first cover 110 is not supported at the rear edge 112 by means of two lateral levers. At the rear edge 112, only the central support by means of the centrally arranged slider 150 is provided.

The slider 150 has a cover connection 155 which is rigidly attached to the pane of the cover 110. By means of a rotary joint 154, the cover connection 155 is pivotable relative to the guide rail 140.

An engagement element 157 of the slider 150 is guided in the guide rail. The engagement element 157 and the cover connection 155 are pivotably connected together by means of the joint 154.

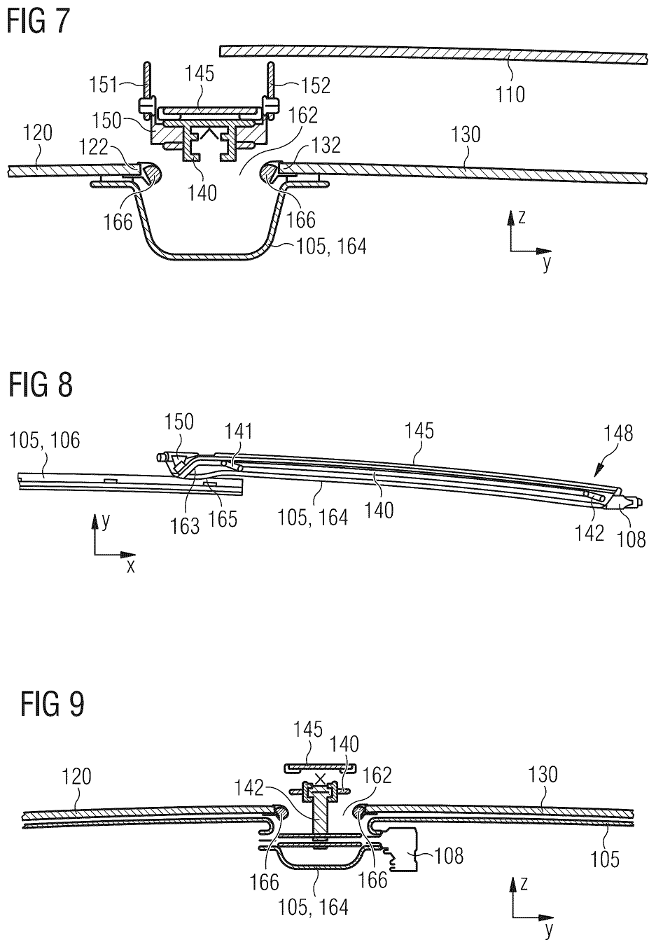

As shown for example in FIGS. 5 and 7, the slider 150 has two side regions 151, 152. The two side regions 151, 152 are arranged on opposite sides of the guide rail 140 in the transverse direction Y. The two side regions 151, 152 each have an associated engagement element 157. The engagement elements 157 of the two side regions 151, 152 engage in the guide rail 140 on opposite sides in the transverse direction Y. Thus it is possible that the slider 150 laterally surrounds the side rail. The engagement between the slider 150 and the guide rail 140 takes place in the transverse direction Y, and in particular not in the vertical direction Z.

In order to move the first cover 110 out of the closed position (FIG. 4) towards the open position (FIG. 5), both the first drive 107 and the second drive 108 are actuated, for example coupled to two lateral front supports 114. The lateral supports 114 are guided in the side guide rails 106. The lateral front supports 114 are connected to the first cover 110 in the front region 116. In particular, the front supports 114 are pivotably attached to the cover carrier 115 on the left and right at the front edge 111 of the first cover 110.

The first drive 107 is configured to raise firstly the front edge 112 of the first cover 110 in the vertical direction Z, starting from the closed position, in that the slider 150 is pushed upward along the sloping portion 144. Then the first cover 110 is displaced in the longitudinal direction X, in that the first drive 107 pushes the front supports 114 towards the rear in the longitudinal direction X, relative to the side guide rails 106. Here, the slider 150 is also pushed towards the rear in the longitudinal direction X in the straight region of the guide rail 140. Before this displacement in the longitudinal direction X in the straight region of the guide rail 140 takes place, the guide rail 140 is raised in the vertical direction Z out of the lowered position, shown in FIG. 4, into the deployed position (FIG. 5). The raising of the guide rail 140 is driven by the second drive 108.

When the guide rail 140 is raised, the slider 150 can be displaced in the vertical direction Z relative to the guide rail 140 and hence also relative to the second cover 120 and third cover 130. The slider 150 is then arranged in the guide rail 140 above the second and third covers 120, 130. Thus an unhindered displacement of the slider 150 along the guide rail 140 is possible. The first cover 110 is thus displaceable in the longitudinal direction X over the second cover 120 and over the third cover 130.

In the closed position, the rear edge 112 of the first cover 110 adjoins the capping 145, as shown for example in FIG. 4. The capping 145 is raised and lowered in the vertical direction Z together with the guide rail 140. The slider 150 with the two side regions 151, 152 thus also laterally surrounds the capping 145.

In the closed position, the capping 145 closes water-tightly with the surrounding covers 110, 120, 130, and in some cases a portion of the fixed vehicle roof. For this for example, additional seals 166 are provided.

In the deployed state of the guide rail 140, the space 162 between the second pane 120 and the third pane 130 is not closed fluid-tightly by the capping 145. Water can therefore penetrate, but is captured in a frame centrepiece 164 and discharged in controlled fashion.

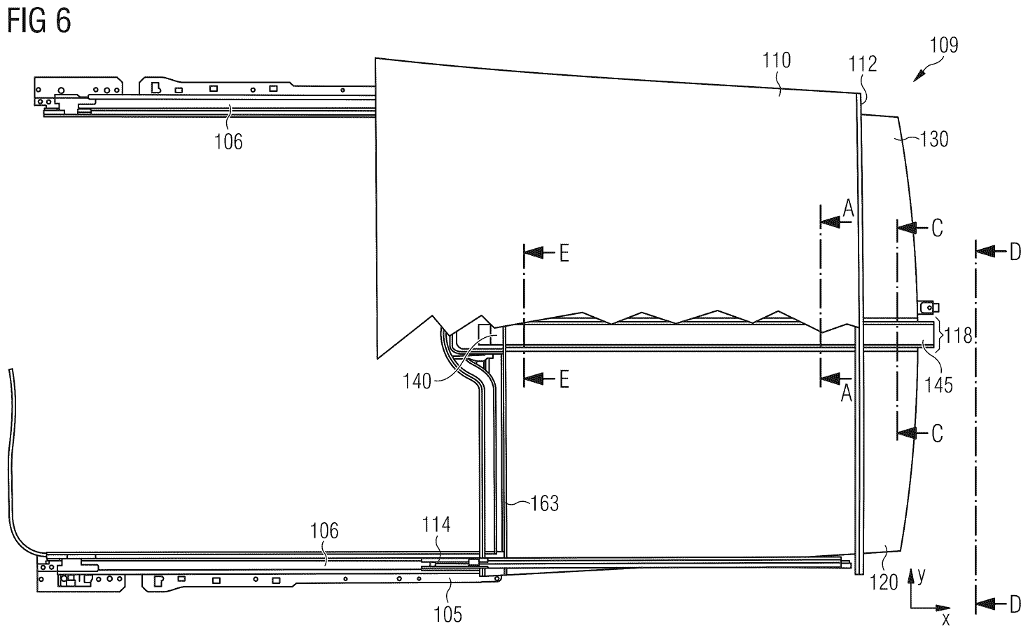

FIG. 7 shows a section along line A-A of FIG. 6. The guide rail 140 is raised out of the frame centrepiece 164 in the vertical direction Z, above the second pane 120 and the third pane 130. At the side of the guide rail 140, the two side regions 141, 142 of the slider 150 connect the first cover 110 to the guide rail 140. The capping 145 covers the guide rail 140 from above. In the transverse direction Y, the second cover 120 and the third cover 130 are arranged spaced apart from one another so as to create the space 162. The space 162 allows the guide rail 140 to be raised and lowered in the vertical direction Z between the first cover 120 and the third cover 130.

FIG. 8 shows a side view of the frame 105 in the closed position. The side guide rails 106 are arranged at the front in the longitudinal direction X. A frame crosspiece 163 is formed in a region of the rear edge 112 of the first cover 110 and of the front region 143 of the guide rail 140. The frame crosspiece 163 extends, longitudinally extended, in the transverse direction Y and in particular connects the two side guide rails 106 together. The frame centrepiece 164 is supported on the frame crosspiece 163. The lowered region 165 is formed in a common portion of the frame crosspiece 163 and the frame centrepiece 164. The guide rail 140 extends towards the rear in the longitudinal direction X, starting from the frame crosspiece 163.

The frame centrepiece 164 also extends towards the rear in the longitudinal direction X, starting from the frame crosspiece 163. The side edge 122 of the second cover and the side edge 132 of the third cover are supported on and attached to the frame centrepiece 164.

FIG. 9 shows a section along line C-C of FIG. 6. The rear deployment lever 142 is coupled to the second drive 108. The second drive 108 and the second deployment lever 142 are each supported and held on the frame 105, and in particular on the frame centrepiece 164. In particular, the second deployment lever 142 is pivotably fixed to the frame centrepiece 164. The second deployment lever 142 can be raised and lowered by means of the pivot movement, in the space 162 between the second cover 120 and the third cover 130. In the position shown, the capping 145 is arranged above the second cover 120 and the third cover 130. When the second deployment lever 142 is pivoted downward so that the first cover 110 closes the roof opening, the capping 145 moves in the vertical direction Z at the level of the second cover 120 and the third cover 130 and, together with the seals 166, closes the space 162.

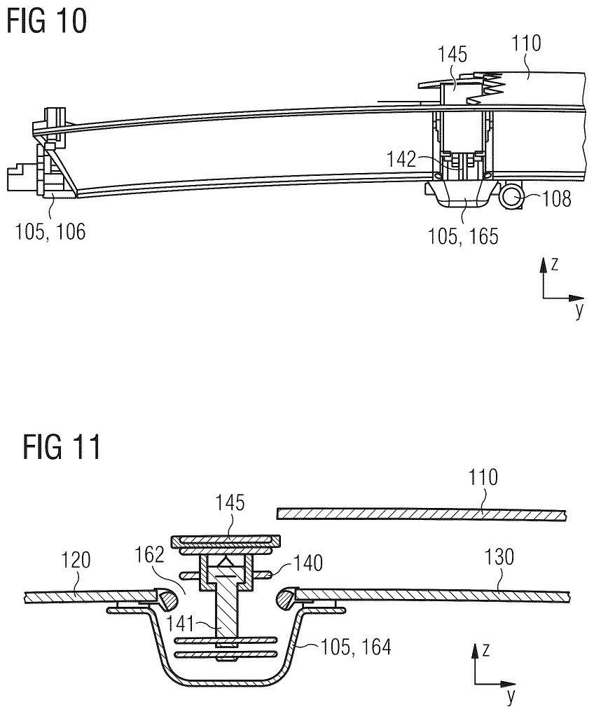

FIG. 10 shows a view of the arrangement 109 from behind (line D-D in FIG. 6). The lowered region 165 protrudes downward in the vertical direction Z beyond the rest of the frame centrepiece 164, in order to offer sufficient stowage space for the sloping portion 144 of the guide rail 140 in the closed position.

FIG. 11 shows a sectional view along line E-E of FIG. 6. The first deployment lever 141 is supported on the frame 105 and in particular on the frame centrepiece 164. In particular, the first deployment lever 141 is pivotably fixed to the frame centrepiece 164. In the deployed position, the first deployment lever 141 extends in the vertical direction Z from the frame centrepiece 164 through the space 162 to above the second cover 120 and the third cover 130. Thus the first cover 110 can be supported and guided on the guide rail 140 above the second and third covers 120, 130.

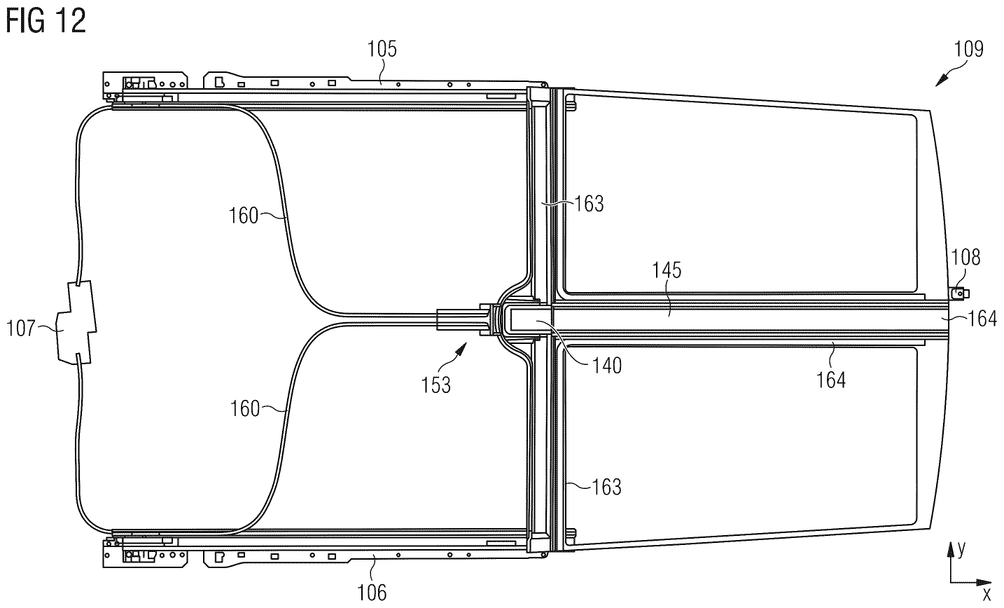

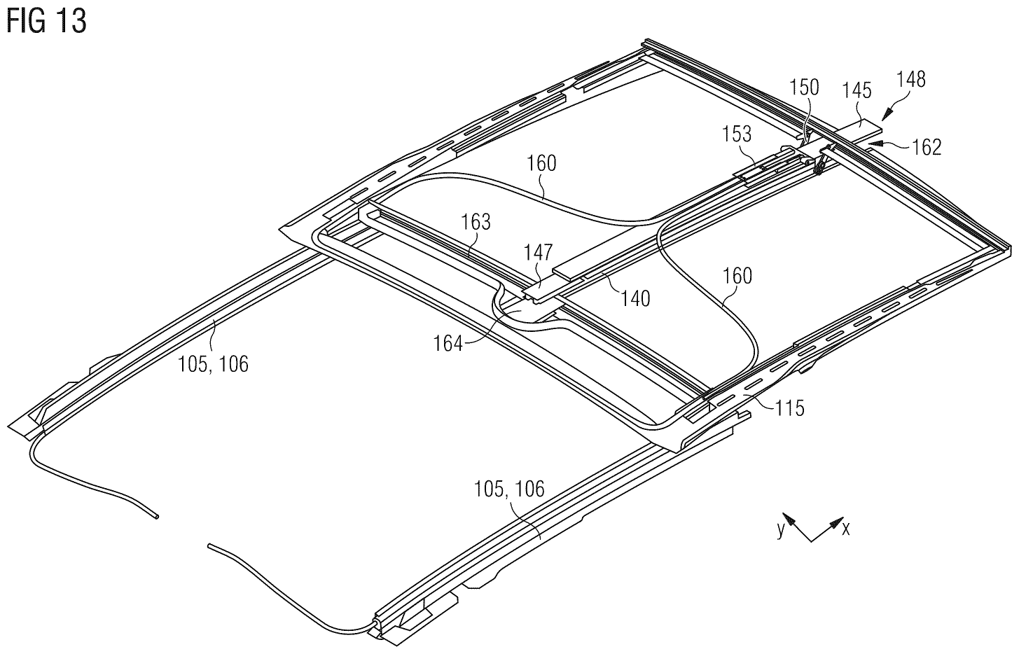

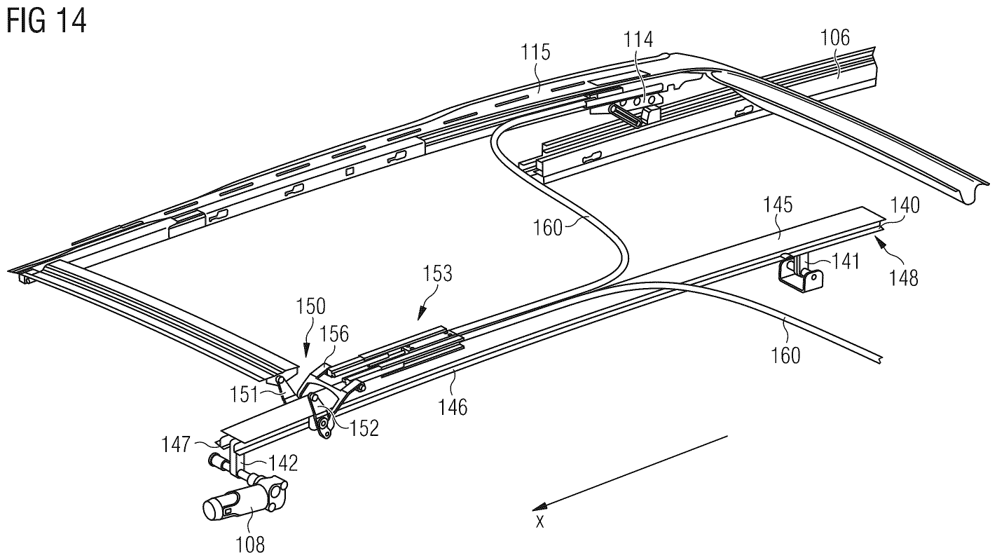

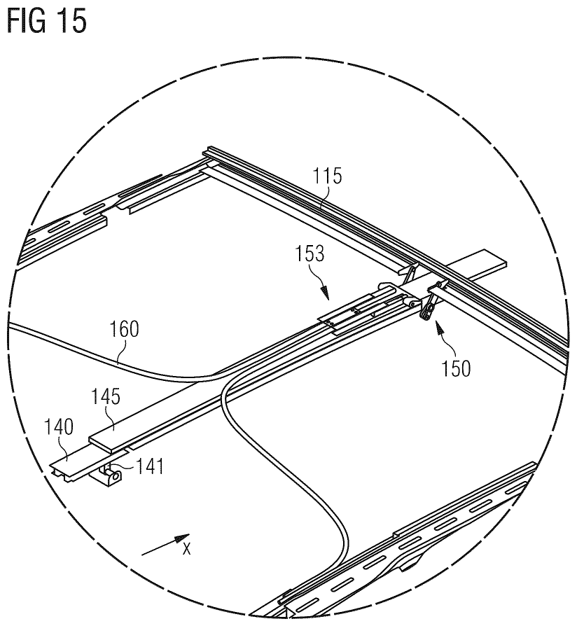

FIGS. 12 to 18 show the arrangement 109 according to a further exemplary embodiment. The exemplary embodiment of FIGS. 12 to 18 substantially corresponds to the exemplary embodiment of FIGS. 4 to 11. Therefore, primarily the differences are discussed in the description below. The other descriptions, features and advantages apply correspondingly and similarly to all exemplary embodiments, in particular also in combination with the further features described herein.

The guide rail 140 according to the exemplary embodiment of FIGS. 12 to 18 has a completely straight course 146 between the first end 147 and the second end 148. The guide rail 140 for example takes the course 146, which follows, in straight and parallel fashion, the slightly curved, streamlined surface of the roof. The guide rail 140 does not have the sloping portion 144 in the front region 143. Thus it is also possible to omit the lowered region 165 in the frame 105. Thus in particular, no installation space in the vertical direction Z need be made available in the lowered region 165, and in particular thereby more room can be provided in the vehicle interior.

The guide rail 140, and in particular a guide channel for the slider 150, extends along the entire length of the guide rail 140 in straight and for example slightly curved fashion. In order to raise and lower the rear edge 112 of the first cover 110 between the closed position and the ventilation position, instead of the sloping portion 144, a pivot mechanism 153 is provided. The pivot mechanism 153 is configured to pivot the slider 150. By means of the pivot mechanism 153, the slider 150 is actively pivotable in order to move the rear edge 112 of the first cover 110 in the vertical direction Z.

The pivot mechanism 153 is in particular driveable by means of the first drive 107. A drive energy of the first drive 107 is transmitted to the pivot mechanism 153 by means of a drive cable 161, and thus used to drive the pivoting of the slider 150.

Two guide tubes 160 are attached to the first cover 110. For example, the guide tubes 160 are mounted on a pane of the first cover 110 by means of a plastic. The guide tubes 160 extend from the front region 116 to the rear region 117. The pivot mechanism 113 is arranged in the rear region 117.

The drive cables 161 are displaceably guided in the guide tubes 160. The guide tubes 160 and the drive cables 161 thus move together with the first cover 110 when the latter is moved relative to the frame 105. When the first cover 110 is in the closed position, the drive cables 161 are connected to the first drive 107, so that the drive energy of the first drive 107 can be transmitted to the pivot mechanism 153. Thus the pivot mechanism 153 is coupled to the first drive 107 so as to allow active pivoting of the slider 150 and to hold the slider 150 stable in its deployed position, when no raising or lowering of the rear edge 112 of the first cover 110 is desired during displacement of the first cover 110 in the longitudinal direction X.

For example, the two side regions 151, 152 of the slider 150 are coupled to the drive cables 161 by means of an intermediate lever 156. The intermediate lever 156 for example connects the drive cables 161 to the slider 150 so that a linear movement of the drive cables 161 is translated into the pivot movement of the slider 150.

In the closed state (see for example FIG. 16), the intermediate lever 156 is configured to move from the region of the first cover 110, over the seal 166 on the frame crosspiece 163, up to the slider 150 on the guide rail 140.

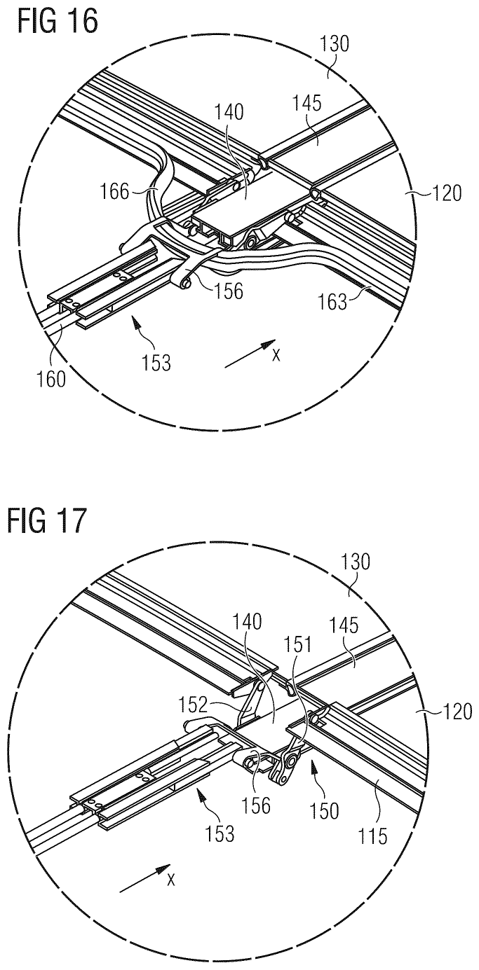

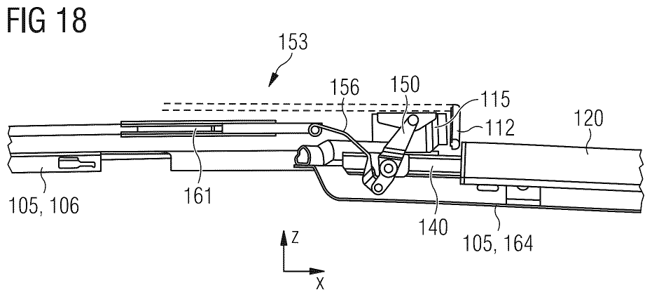

As evident for example from FIGS. 17 and 18, the intermediate lever 156 is driven by the drive cable 161 in order to pivot the slider 150 into the ventilation position and hold it there. The slider 150 is pivoted relative to the guide rail 140 between the closed position and the ventilation position, while the guide rail 140 remains stationary. In particular, it is not necessary to displace the slider 150 along the guide rail 140 for pivoting. The second drive 108 pivots the second deployment lever 142 so that the straight guide rail 140 is raised. The first cover 110 is then displaceable in the longitudinal direction along the guide rail 140, as already explained.

The guide tubes 160 and the pivot mechanism 153 are displaced together with the first cover 110 so that, in the open position, the roof opening 104 can be opened unobstructed by the guide tubes 160 and pivot mechanism 153. For example, the pane of the first cover 110 is tinted so that, even in the closed position, an attractive overall appearance of the arrangement 109 is possible even with the guide tubes 160 and the pivot mechanism 153.

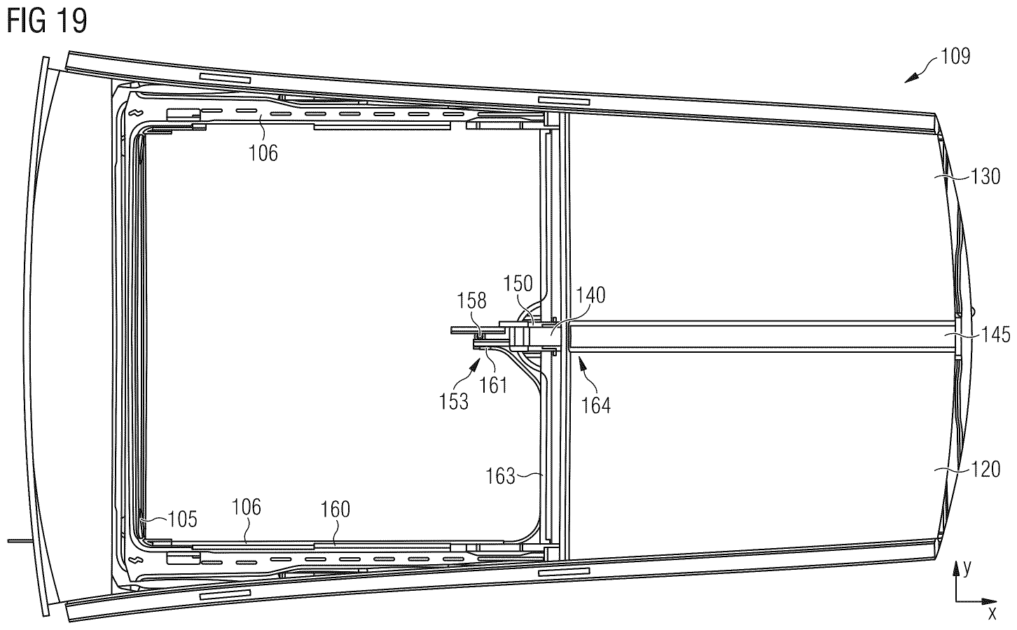

FIGS. 19 to 21 show the arrangement 109 according to a further exemplary embodiment. The exemplary embodiment substantially corresponds to the exemplary embodiments already described, in particular the exemplary embodiment of FIGS. 12 to 18. Therefore, primarily the differences are discussed in the description below. The other descriptions, features and advantages apply correspondingly and similarly to all exemplary embodiments, in particular also in combination with the further features described herein.

The exemplary embodiment in FIGS. 19 to 21 has the pivot mechanism 153, which is however configured differently from that in the exemplary embodiment of FIGS. 12 to 18. According to FIGS. 19 to 21, in the closed position, the guide tube 160 is arranged in the region of one of the side guide rails 106. Thus the transparent surface of the first cover 110 is larger and not obstructed by the guide tubes 160.

In particular, only a single guide tube 160 is provided. The drive cable 161 is guided in the guide tube 160, which is arranged at the side on the first cover 110, in order to transmit a drive energy of the first drive 107 to the pivot mechanism 153. The drive cable 161 runs in the longitudinal direction X on one of the side edges 113 of the first cover 110, and in the transverse direction Y on the rear edge 112 of the first cover.

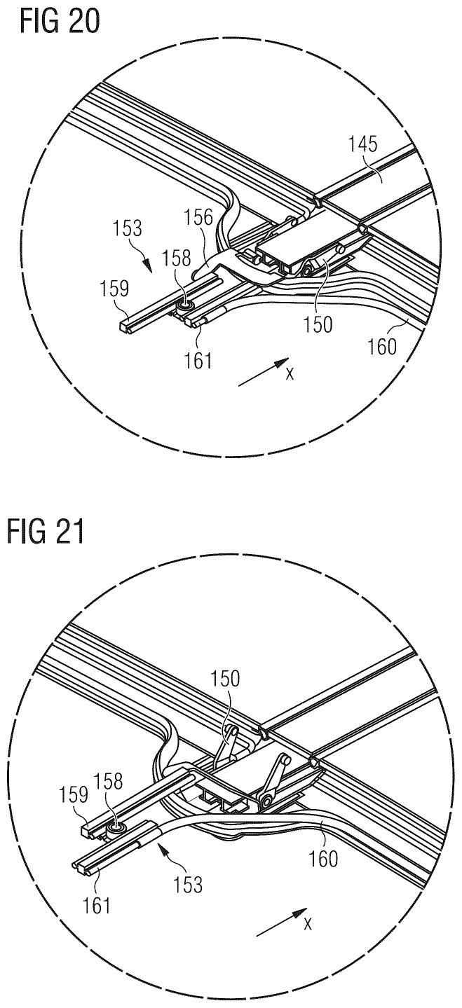

FIG. 20 shows the slider 150 in the retracted position, in which the first cover 110 is in the closed position. FIG. 21 shows the slider 150 in the deployed position, in which the rear edge 112 of the first cover 110 is raised, i.e. in particular in the ventilation position.

For deployment of the slider 150 between the position in FIG. 20 and the position in FIG. 21, the drive cable 161 moves forward in the longitudinal direction X in the region of the pivot mechanism 153. The pivot mechanism 153 has a pinion 158, which is set in rotation by the linear movement of the drive cable 161. An intermediate piece 159, which is in engagement with the pinion 158, is thereby moved towards the rear in the longitudinal direction X. Thus the movement of the drive cable 161 in the direction of the windscreen 103 is converted into a movement of the intermediate piece 159 in the direction of the rear window. The intermediate piece 159 is coupled to the intermediate lever 156. The movement of the intermediate piece 159 thus drives the active pivoting of the slider 150.

The arrangement 109 according to the various exemplary embodiments allows the first cover 110 to be supported on the centrally arranged, raisable and lowerable guide rail 140. Thus the cover 110 can reliably be configured as an externally guided sliding roof with the slider 150, even if the side edges 113 are greatly waisted, or if the front edge 111, the rear edge 112 and the side edges 113 form a trapezium or are arranged in trapezoid form. The second cover 120 and the third cover 130 may also be formed greatly waisted. The rear support of the cover 110 is provided centrally on the guide rail 140. There is therefore no need for rails on the outer sides in the region of the second cover 120 and the third cover 130. Thus the sides of the second cover 120 and the third cover 130 facing away from the guide rail 140 can be designed in flexible fashion, since there is no need for guide rails arranged in parallel. This also allows a waisted arrangement of the side parts of the frame 105 running in the longitudinal direction X.

The covers 110, 120, 130 each have a transparent, translucent or opaque, tinted pane. The pane is for example a glass pane and/or a plastic pane.

The capping 145 is for example also made of glass, and in particular configured with a similar optical appearance as the second cover 120 and the third cover 130, i.e. for example also tinted. Alternatively, it is also possible that the capping 145 is made of a plastic, e.g. a polycarbonate. The arrangement 109 allows a comparatively large difference between the transverse extent in the transverse direction Y at the front side of the arrangement 109, and the transverse extent in the transverse direction Y at the rear side of the arrangement, but nonetheless with a large opening width for the first cover 110 because of the support by means of the slider 150, which is always supported on the guide rail 140 in the manner of an externally guided sliding roof, and is rigidly and stationarily attached to the first cover 110 in the longitudinal direction X.

In the region of the arrangement 109 which, in the closed state, adjoins the rear edge 112 of the first cover 110, the second cover 120 and the third cover 130 are arranged with the guide rail 140 and the capping 145 in between. The guide rail 140 can be raised or lowered in the Z direction by means of the first deployment lever 141 and the second deployment lever 142, in the manner of a parallelogram or four-bar linkage. In the closed state, the capping 145 seals water-tightly with the second cover 120 and the third cover 130. Below the guide rail 140 in the Z direction, the frame 105 has the frame centrepiece 164 which forms a closed wet region.

In order to hold the first cover 110 reliably on the frame 105 in the closed position, an additional locking may be provided, which for example is implemented by means of the first drive 107 and/or the second drive 108.

The arrangement 109 thus allows, even with large and heavy covers, reliable operation for displacing the first cover 110 and a comparatively wide opening of the roof opening 104 in the open position.

### LIST OF REFERENCE SIGNS

100 Vehicle
101 Vehicle roof
102 Rear window
103 Windscreen
104 Roof opening
105 Frame
106 Side guide rails
107 First drive
108 Second drive
109 Arrangement
110 First cover
111 Front edge
112 Rear edge
113 Side edge
114 Front support
115 Cover carrier
116 Front region
117 Rear region
118 Middle region
120 Second cover
121 Front edge
122 Side edge
130 Third cover
131 Front edge
132 Side edge
140 Guide rail
141 First deployment lever
142 Second deployment lever
143 Front region
144 Sloping portion
145 Capping
146 Course
147 First end
148 Second end
150 Slider
151, 152 Side regions
153 Pivot mechanism
154 Joint
155 Cover connection
156 Intermediate lever
157 Engagement element
158 Pinion
159 Intermediate piece
160 Guide tube
161 Drive cable
162 Space
163 Frame crosspiece
164 Frame centrepiece
165 Lowered region
166 Seal
X Longitudinal direction
Y Transverse direction
Z Vertical direction.

1. An arrangement for a vehicle roof, having:
a frame for coupling to the vehicle roof,
a first cover which is displaceable relative to the frame in a first direction,
a second cover and a third cover which are each attached stationarily to the frame,
a guide rail which is longitudinally extended in the first direction, wherein the guide rail is coupled to the frame, is arranged between the second and third covers in a second direction, and is movable relative to the frame in a third direction, and wherein the first direction, the second direction and the third direction are each oriented transversely to one another,
a slider which is attached to the first cover and which is guided in the guide rail.

2. The arrangement according to claim 1, having:
a first drive for driving a displacement of the first cover relative to the frame, and
a second drive (108) for driving a movement of the guide rail relative to the frame.

3. The arrangement according to claim 1, having:
a common drive for driving a displacement of the first cover relative to the frame and for driving a movement of the guide rail relative to the frame.

4. The arrangement according to claim 1, wherein the slider is configured to surround the guide rail so that the guide rail is arranged between two side regions of the slider in the second direction.

5. The arrangement according to claim 1, having a first deployment lever and a second deployment lever, which are each coupled to the frame and to the guide rail and are each pivotable relative to the frame in order to move the guide rail.

6. The arrangement according to claim 1, wherein the first cover has a front edge and a rear edge which each run in the second direction, wherein the rear edge is shorter than the front edge.

7. The arrangement according to claim 1, wherein the first cover has two front supports which are arranged at the side in a front region of the first cover and are coupled to the frame, and wherein the slider is arranged in a rear region of the first cover, centrally in the second direction.

8. The arrangement according to claim 1, wherein the guide rail has a sloping portion in a front region.

9. The arrangement according to claim 1, having a pivot mechanism for pivoting the slider relative to the guide rail.

10. The arrangement according to claim 9, having a guide tube which is attached to the first cover, and a drive cable which is displaceably guided in the guide tube, wherein the drive cable is coupled to the pivot mechanism.

11. The arrangement according to claim 1, having a capping which covers the guide rail and, when the first cover is in a closed state, seals a space between the second and third covers.

12. A vehicle roof having the arrangement according to claim 1.
